(19) United States
(12) Patent Application Publication
(10) Pub. No.: US 2024/0388959 A1
(43) Pub. Date: Nov. 21, 2024

(54) THROUGHPUT ENHANCEMENTS FOR MULTI-LINK OPERATIONS

(71) Applicant: QUALCOMM Incorporated, San Diego, CA (US)

(72) Inventors: Guido Robert FREDERIKS, Watsonville, CA (US); Ruiqing YE, Alviso, CA (US); Shivaprakasha BELADERI, Tracy, CA (US)

(21) Appl. No.: 18/320,641

(22) Filed: May 19, 2023

(51) Int. Cl. H04W 28/02; H04L 5/00

(52) U.S. Cl. CPC H04W 28/0273; H04L 5/0053

(57) ABSTRACT

Certain aspects of the present disclosure are directed towards enhancing throughput for multi-link operations. One example method at a first wireless node generally includes: determining a first ratio of a first traffic on each of one or more of multiple links between the first wireless node and a second wireless node based on at least one characteristic of the one or more of the multiple links, wherein the first traffic comprises Transmission Control Protocol (TCP) or Internet Protocol (IP) traffic; and outputting the first traffic for transmission to the second wireless node in accordance with the first ratio.

### TECHNICAL FIELD

This disclosure relates generally to wireless communication, and more specifically, to determining a ratio of uplink and downlink traffic on each link for a multi-link device (MLD).

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

### SUMMARY

The systems, methods and devices of this disclosure each have several innovative aspects, no single one of which is solely responsible for the desirable attributes disclosed herein.

Certain aspects of the present disclosure include a method for wireless communication at a first wireless node. The method generally includes determining a first ratio of a first traffic on each of one or more of multiple links between the first wireless node and a second wireless node based on at least one characteristic of the one or more of the multiple links, where the first traffic may include transmission control protocol or internet protocol traffic; and outputting the first traffic for transmission to the second wireless node in accordance with the first ratio.

Certain aspects of the present disclosure include an apparatus for wireless communication at a first wireless node. The apparatus generally includes one or more processors, memory coupled with the one or more processors, and instructions stored in the memory and executable by the one or more processors to cause the apparatus to: determine a first ratio of a first traffic on each of one or more of multiple links between the first wireless node and a second wireless node based on at least one characteristic of the one or more of the multiple links, where the first traffic may include transmission control protocol or internet protocol traffic; and output the first traffic for transmission to the second wireless node in accordance with the first ratio.

Certain aspects of the present disclosure include a non-transitory computer-readable medium having instructions stored thereon. The non-transitory computer-readable medium also includes determine a first ratio of a first traffic on each of one or more of multiple links between the first wireless node and a second wireless node based on at least one characteristic of the one or more of the multiple links, where the first traffic may include transmission control protocol or internet protocol traffic; and output the first traffic for transmission to the second wireless node in accordance with the first ratio.

Certain aspects of the present disclosure include an apparatus for wireless communication at a first wireless node. The apparatus also includes means for determining a first ratio of a first traffic on each of one or more of multiple links between the first wireless node and a second wireless node based on at least one characteristic of the one or more of the multiple links, where the first traffic may include transmission control protocol or internet protocol traffic; and

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a pictorial diagram of another example wireless communication network.

FIG. 3 shows a block diagram of an example multi-link device (MLD) deployment.

FIGS. 4A and 4B illustrate data and ACK traffic on a link between a first wireless node and a second wireless node.

FIGS. 5A and 5B illustrate data and ACK traffic on multiple links between as first wireless node and a second wireless node.

FIG. 6 illustrates a device having a link monitoring component and a traffic generator component, in accordance with certain aspects of the present disclosure.

FIGS. 7A and 7B illustrate data traffic dedicated to a first link and acknowledgement traffic dedicated to a second link, in accordance with certain aspects of the present disclosure.

FIG. 8 is a table illustrating different allocations of data and acknowledgements for two links, in accordance with certain aspects of the present disclosure.

FIG. 9 is a timing diagram illustrating example operations for multi-link communication, in accordance with certain aspects of the present disclosure.

FIG. 10 is a flow diagram illustrating example operations for wireless communication, in accordance with certain aspects of the present disclosure.

FIG. 11 shows aspects of an example communications device. Like reference numbers and designations in the various drawings indicate like elements.

### DETAILED DESCRIPTION

Certain aspects of the present disclosure are directed to techniques for enhancing throughput for multi-link operations (MLO). For example, multiple links may be implemented between wireless nodes. Each link may be bidirectional. In other words, each wireless node may transmit on each link. A first wireless node may transmit data on any one of the links and a second wireless node may transmit acknowledgements (ACK) for the data on any one of the links. Therefore, collisions of transmissions (collisions of data and ACK transmissions) by the wireless nodes may occur, resulting in a reduction of overall throughput. In some cases, the bandwidth on one or more links may be large. For example, one link may be have a 320 MHz bandwidth, where as another link may have a 20 MHz bandwidth. Thus, a collision occurring on the large bandwidth link may result in a great amount of data loss, significantly reducing overall throughput for the MLO. In some aspects, of the present disclosure, a ratio of data and ACK traffic may be allocated on each of the multiple links. For example, all data may allocated for transmission on a first link and all ACK traffic may be allocated for transmission on a second link, reducing collisions and increasing throughput. Any suitable ratio of traffic may be selected for transmission on each link. For instance, 60% of data traffic may be allocated for the first link and 40% of the data traffic may be allocated for the second link. The determination of the ratio may be based on one or more factors, such as the data rate of each link, the aggregate data rate of the multiple links, a difference in data rate between the multiple links, a latency associated with ACK transmissions, or any combination thereof.

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

A multi-link device (MLD) generally consists of one or more affiliated STAs. An AP MLD generally refers to an MLD whose affiliated STA(s) are AP(s). A non-AP MLD generally refers to an MLD whose affiliated STA(s) are non-AP STA(s). Each STA of an MLD operates on a link.

Multi-link operation (MLO) generally refers to a feature in advanced wireless systems (e.g., 802.11be Extremely High Throughput (EHT)) that enables the utilization of multiple links using individual frequency channels to transmit and receive between devices. MLO may enable concurrent utilization of multiple radio links of different frequency channels/bands by an AP, a client, or both.

MLO enables a pair of devices to use multiple wireless links in different bands simultaneously for transmission and reception. MLO allows simultaneous use of multiple bands and also enhances the throughput of a single data session, while current multiband APs may allow client devices to connect using only one band at a time. Ideally, the maximum achievable throughput of MLO is the sum of the achievable throughput for each link.

In some systems, a direct link between client devices, referred to as a peer-to-peer (P2P) or direct link, may be established between stations, while one or more of the stations may also remain associated with an AP. These P2P mechanisms may help reduce the amount of traffic that is transferred in the network and prevent congestion at the AP. A P2P link may be set up automatically between the devices, without intervention from the AP or the user, and the connection with the AP may be maintained.

### EXAMPLE WIRELESS COMMUNICATION NETWORK

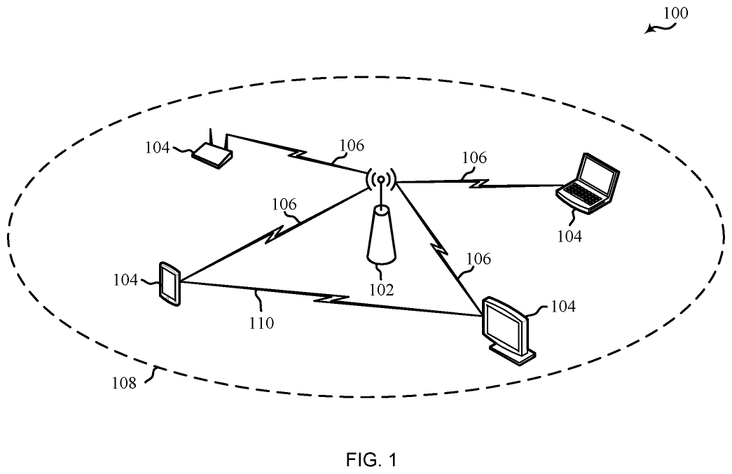

FIG. 1 shows a block diagram of an example wireless communication network 100. According to some aspects, the wireless communication network 100 can be an example of a WLAN such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11bc, 802.11bf. and the 802.11 amendment associated with Wi-Fi 8). The WLAN 100 may include numerous wireless communication devices such as a wireless AP 102 and multiple wireless STAs 104. While only one AP 102 is shown in FIG. 1, the WLAN network 100 also can include multiple APs 102. AP 102 shown in FIG. 1 can represent various different types of APs including but not limited to enterprise-level APs, single-frequency APs, dual-band APs, standalone APs, software-enabled APs (soft APs), and multi-link APs. The coverage area and capacity of a cellular network (such as LTE, 5G NR, etc.) can be further improved by a small cell which is supported by an AP serving as a miniature base station. Furthermore, private cellular networks also can be set up through a wireless area network using small cells.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, chromebooks, extended reality (XR) headsets, wearable devices, display devices (for example, TVs (including smart TVs), computer monitors, navigation systems, among others), music or other audio or stereo devices, remote control devices (“remotes”), printers, kitchen appliances (including smart refrigerators) or other household appliances, key fobs (for example, for passive keyless entry and start (PKES) systems), Internet of Things (IoT) devices, and vehicles, among other examples. The various STAs 104 in the network are able to communicate with one another via the AP 102.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified or indicated to users by a service set identifier (SSID), as well as to other devices by a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to one or more of the IEEE 802.11 family of wireless communication protocol standards. These standards define the WLAN radio and baseband protocols for the PHY and MAC layers. The APs 102 and STAs 104 transmit and receive wireless communications (hereinafter also referred to as “Wi-Fi communications” or “wireless packets”) to and from one another in the form of PHY protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some examples of the APs 102 and STAs 104 described herein also may communicate in other frequency bands, such as the 5.9 GHz and the 6 GHz bands, which may support both licensed and unlicensed communications. The APs 102 and STAs 104 also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4 GHz, 5 GHz or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

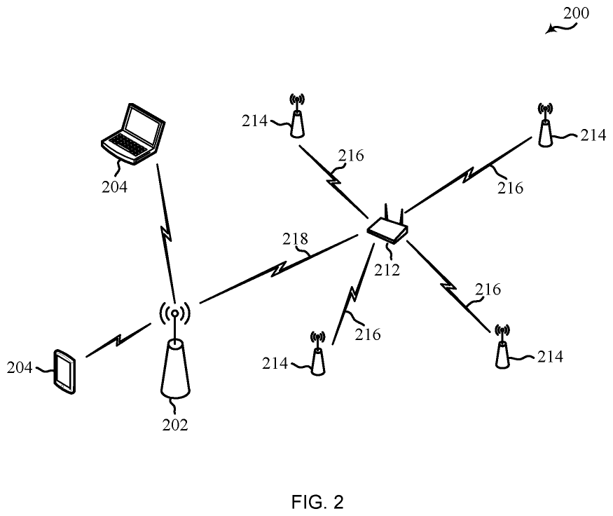

FIG. 2 shows a pictorial diagram of another example wireless communication network 200. According to some aspects, the wireless communication network 200 can be an example of a mesh network, an IoT network or a sensor network in accordance with one or more of the IEEE 802.11 family of wireless communication protocol standards (including the 802.11ah amendment). The wireless network 200 may include multiple wireless communication devices 214. The wireless communication devices 214 may represent various devices such as display devices (for example, TVs, computer monitors, navigation systems, among others), music or other audio or stereo devices, remote control devices (“remotes”), printers, kitchen or other household appliances, among other examples.

In some examples, the wireless communication devices 214 sense, measure, collect or otherwise obtain and process data and then transmit such raw or processed data to an intermediate device 212 for subsequent processing or distribution. Additionally or alternatively, the intermediate device 212 may transmit control information, digital content (for example, audio or video data), configuration information or other instructions to the wireless communication devices 214. The intermediate device 212 and the wireless communication devices 214 can communicate with one another via wireless communication links 216. In some examples, the wireless communication links 216 include Bluetooth links or other PAN or short-range communication links.

In some examples, the intermediate device 212 also may be configured for wireless communication with other networks such as with a Wi-Fi WLAN or a wireless (for example, cellular) wide area network (WWAN), which may, in turn, provide access to external networks including the Internet. For example, the intermediate device 212 may associate and communicate, over a Wi-Fi link 218, with an AP 202 of a WLAN network, which also may serve various STAs 204. In some examples, the intermediate device 212 is an example of a network gateway, for example, an IoT gateway. In such a manner, the intermediate device 212 may serve as an edge network bridge providing a Wi-Fi core backhaul for the IoT network including the wireless communication devices 214. In some examples, the intermediate device 212 can analyze, preprocess and aggregate data received from the wireless communication devices 214 locally at the edge before transmitting it to other devices or external networks via the Wi-Fi link 218. The intermediate device 212 also can provide additional security for the IoT network and the data it transports.

Aspects of transmissions may vary according to a distance between a transmitter (for example, an AP 102 or a STA 104) and a receiver (for example, another AP 102 or STA 104). Wireless communication devices may generally benefit from having information regarding the location or proximities of the various STAs 104 within the coverage area. In some examples, relevant distances may be determined (for example, calculated or computed) using RTT-based ranging procedures. Additionally, in some examples, APs 102 and STAs 104 may perform ranging operations. Each ranging operation may involve an exchange of fine timing measurement (FTM) frames (such as those defined in the 802.11az amendment to the IEEE family of wireless communication protocol standards) to obtain measurements of RTT transmissions between the wireless communication devices.

### Overview of Multi-Link Devices

As initially described above, a multi-link device (MLD) generally refers to a single device or equipment that includes two or more station (STA) instances or entities, implemented in a physical (PHY)/medium access control (MAC) layer and configured to communicate on separate wireless links. In some examples, each MLD may include a single higher layer entity, such as a MAC Service Access Point (SAP) that may assign MAC protocol data units (MPDUs) for transmission by the separate STA instances.

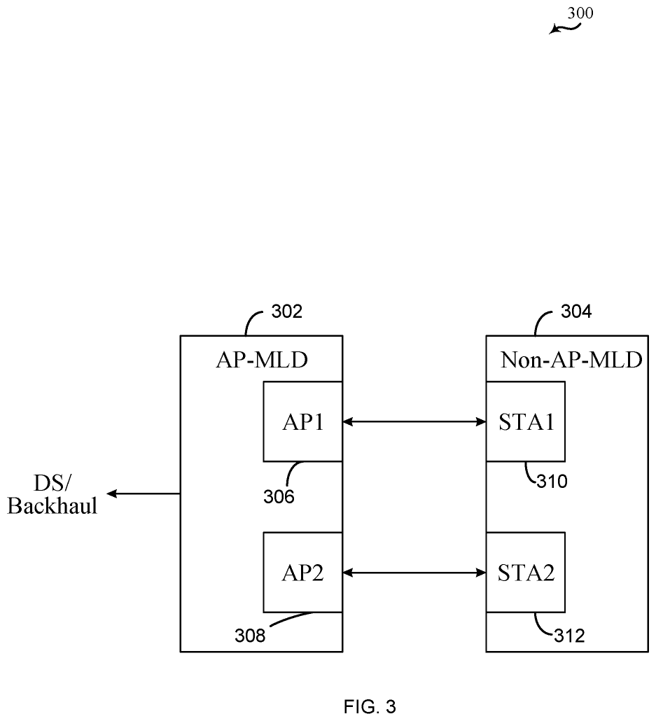

FIG. 3 shows a block diagram of an example MLD deployment 300. Some wireless communication devices (including both APs and STAs) are capable of multi-link operation (MLO). In some examples, MLO supports establishing multiple different communication links (such as a first link on the 2.4 GHz band, a second link on the 5 GHz band, and the third link on the 6 GHz band) between the STA and the AP. Each communication link may support one or more sets of channels or logical entities. In some cases, each communication link associated with a given wireless communication device may be associated with a respective radio of the wireless communication device, which may include one or more transmit/receive (Tx/Rx) chains, include or be coupled with one or more physical antennas, or include signal processing components, among other components. An MLO-capable device may be referred to as a multi-link device (MLD). For example, an AP MLD 302 may include multiple APs 306, 308 each configured to communicate on a respective communication link with a respective one of multiple STAs 310, 312 of a non-AP MLD 304 (also referred to as a “STA MLD”). The STA MLD may communicate with the AP MLD over one or more of the multiple communication links at a given time.

One type of MLO is multi-link aggregation (MLA), where traffic associated with a single STA is simultaneously transmitted across multiple communication links in parallel to maximize the utilization of available resources to achieve higher throughput. That is, during at least some duration of time, transmissions or portions of transmissions may occur over two or more links in parallel at the same time. In some examples, the parallel wireless communication links may support synchronized transmissions. In some other examples, or during some other durations of time, transmissions over the links may be parallel, but not be synchronized or concurrent. In some examples or durations of time, two or more of the links may be used for communications between the wireless communication devices in the same direction (such as all uplink or all downlink). In some other examples or durations of time, two or more of the links may be used for communications in different directions. For example, one or more links may support uplink communications and one or more links may support downlink communications. In such examples, at least one of the wireless communication devices operates in a full duplex mode. Generally, full duplex operation enables bi-directional communications where at least one of the wireless communication devices may transmit and receive at the same time.

MLA may be implemented in a number of ways. In some examples, MLA may be packet-based. For packet-based aggregation, frames of a single traffic flow (such as all traffic associated with a given traffic identifier (TID)) may be sent concurrently across multiple communication links. In some other examples, MLA may be flow-based. For flow-based aggregation, each traffic flow (such as all traffic associated with a given TID) may be sent using a single one of multiple available communication links. As an example, a single STA MLD may access a web browser while streaming a video in parallel. The traffic associated with the web browser access may be communicated over a first communication link while the traffic associated with the video stream may be communicated over a second communication link in parallel (such that at least some of the data may be transmitted on the first channel concurrently with data transmitted on the second channel).

In some other examples, MLA may be implemented as a hybrid of flow-based and packet-based aggregation. For example, an MLD may employ flow-based aggregation in situations in which multiple traffic flows are created and may employ packet-based aggregation in other situations. The determination to switch among the MLA techniques or modes may additionally or alternatively be associated with other metrics (such as a time of day, traffic load within the network, or battery power for a wireless communication device, among other factors or considerations).

To support MLO techniques, an AP MLD and a STA MLD may exchange supported MLO capability information (such as supported aggregation type or supported frequency bands, among other information). In some examples, the exchange of information may occur via a beacon signal, a probe request or probe response, an association request or an association response frame, a dedicated action frame, or an operating mode indicator (OMI), among other examples. In some examples, an AP MLD may designate a given channel in a given band as an anchor channel (such as the channel on which it transmits beacons and other management frames). In such examples, the AP MLD also may transmit beacons (such as ones which may contain less information) on other channels for discovery purposes.

MLO techniques may provide multiple benefits to a WLAN. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the ON time of a modem, which may benefit a wireless communication device in terms of power consumption. Another benefit of MLO is the increased multiplexing opportunities in the case of a single BSS. For example, multi-link aggregation may increase the number of users per multiplexed transmission served by the multi-link AP MLD.

Various modes of communication may be employed in MLD implementations. For example, a MLD may communicate in an Asynchronous (Async) mode or a Synchronous (Sync) mode. In the Async mode, a STA/AP may count down (for example, via a random backoff (RBO)) on both wireless links. A physical layer convergence protocol (PLCP) protocol data units (PPDU) start/end may happen independently on each of the wireless links. As a result, Async mode may potentially provide latency and aggregation gains. In certain cases, relatively complex (and costly) filters may be needed (for example, in the case of 5 GHz+6 GHz aggregation). In the Sync mode, a STA/AP may also count down on both wireless links (e.g., assuming Link 1 and Link 2). If a first link (e.g., Link 1) wins the medium, both links may transmit PPDUs at the same time. Accordingly, this mode may need some restrictions to minimize in-device interference.

Although not shown, a third mode of communication may include a Basic (for example, multi-primary with single link transmission) mode. In the Basic mode, a STA/AP may also count down on both wireless links. However, transmission may only occur on the wireless link that wins the medium. The other wireless link may be blocked by in-device interference greater than −62 decibels per milliwatt (dBm). No aggregation gains may be realized in this mode.

One potential issue with MLO deployments is blocking, which may need to be addressed for better band management. Other potential issues for APs and clients that may limit MLO deployments is that APs need to manage individual client radio usage and offer service on multiple radios, while limiting the number of links that a single client can switch between. An AP may also want to limit the number of radios that a client can be active (Tx/Rx) on at a time to manage load.

Customers (clients) may view MLO as a tool to adapt to dynamic traffic load, link quality and collocated operations and to achieve. It may be desirable to have autonomy to manage performance. Most scenarios may only need at most two active links, but may want the ability to easily switch between more bands/channels (e.g., to adapt to changing conditions/mobility).

### Techniques for Determining a Ratio of Traffic on a Link

Transmission Control Protocol or Internet Protocol (IP) (TCP/IP) traffic on each link between multi-link devices (MLDs) may be bi-directional. In other words, bidirectional traffic may flow on each link. Large TCP/IP data packets may flow in one direction, and small TCP/IP acknowledgment (ACK) packets may flow in the other direction. When TCP/IP traffic flows over a WiFi connection, the bidirectional traffic may result in medium collisions, and thus, the overall achievable throughput on the link is reduced.

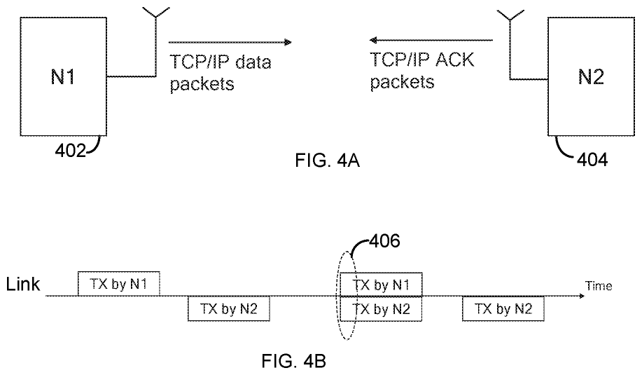

FIGS. 4A and 4B illustrate TCP/IP data and ACK traffic on a link between a first wireless node 402 (labeled “N1”) and a second wireless node 404 (labeled “N2”). The data and ACK traffic may be communicated on the same link. As shown in FIG. 4B, the transmission (TX) by the node 402 (e.g., TX of data packet) on the link may collide (e.g., at time 406) with the TX by the node 404 (e.g. TX of ACK). In other words, if the transmissions by the two nodes 402, 404 overlap, the two transmissions may collide causing dropped frames and reducing throughput on the link.

For TCP/IP downlink, the node 402 may be an access point (AP) sending data packets to the node 404 which may be a STA. The STA responds with ACK packets for the data packets, as shown. For TCP/IP uplink, the node 402 may be a STA sending data packets to the node 404 which may be an AP.

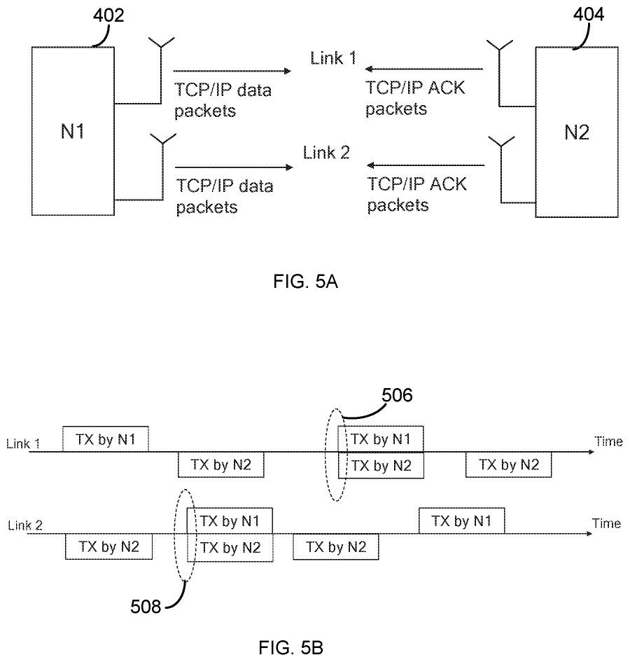

FIGS. 5A and 5B illustrate TCP/IP data and ACK traffic on multiple links between the first wireless node 402 and the second wireless node 404. For multi-link operation (MLO), multiple medium channels (e.g., for second-generation (2G), fifth-generation (5G), or sixth-generation (6G)) may be used to direct TCP/IP traffic, as described. As shown, on each of the links (link 1 and link 2), transmissions may collide. For example, at time 506 on link 1, a TX by the node 402 may collide with a TX by node 404. Similarly, at time 508 on link 2, a TX by node 402 may collide with a TX by node 404.

Certain aspects of the present disclosure are directed to techniques for assessing link characteristics and allocating a ratio of traffic to each link based on link characteristics to increase link efficiency (e.g., throughput). Depending on the overall achievable physical layer (PHY) data rates on the two or more available MLO channels (e.g., links), the TCP/IP data and TCP/IP ACK traffic may be steered in certain ratios on the channels, which may be beneficial to improve throughput. For instance, when one link has a very low data rate (e.g., has a 20 MHz bandwidth (BW)) compared to the other link (e.g., has a 320 MHz BW), TCP/IP ACK traffic may be dedicated (e.g., limited) to only be transmitted on the lowest data rate link. That is, all data traffic may be dedicated to link 1, and all acknowledgment traffic may be dedicated to link 2. The result is that on the highest data rate link, there may be only TCP/IP data traffic. There are no TCP/IP ACK frame transmissions on the highest data rate channel, so zero collisions on the medium and improved throughput may result.

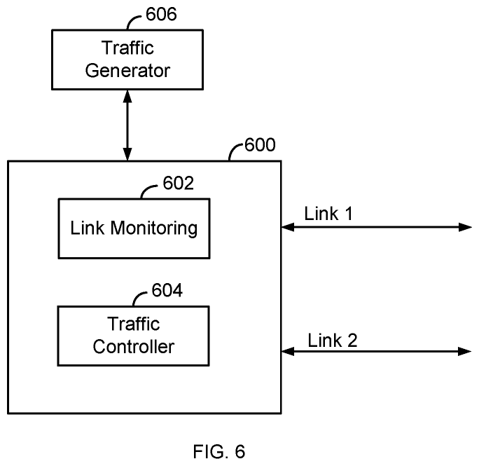

FIG. 6 illustrates an MLD 600 (e.g., corresponding to node 402 or node 404) having a link monitoring component 602 and a traffic controller component 604, in accordance with certain aspects of the present disclosure. The link monitoring component 602 may assess the characteristic of one or more of the multiple links (e.g., link 1 and link 2) of the MLD 600. For example, the link monitoring component 602 may assess the data rate of each of the links or a link performance of each of the links (e.g., number of collisions or packet losses resulting in loss of throughput). The link characteristic may be provided to the traffic controller component 604. Based on the characteristic, the traffic controller component 604 may determine a ratio of the first traffic (e.g., data traffic) and the second traffic (e.g., ACK) on each of the links. For example, suppose the monitoring component 602 identifies a high data rate on link 1 and a low data rate on link 2. In that case, the traffic controller component 604 may dedicate data traffic to link 1 and the acknowledgement traffic to link 2. In some aspects, the monitoring component 602 may determine that link 2 is not able to support the acknowledgment traffic dedicated to link 2, resulting in increased latency for the acknowledgments adversely impacting throughput. Thus, the traffic controller component 604 may adjust the determined ratio to allocate some of the acknowledgment traffic to link 1. For example, 80% of the acknowledgment traffic may be allocated to link 2 and 20% of the acknowledgment traffic may be allocated to link 1. In some aspects, a traffic generator component 606 may generate the data to be communicated by the MLD 600. For instance, the traffic generator component 606 may be a webserver generating TCP/IP data.

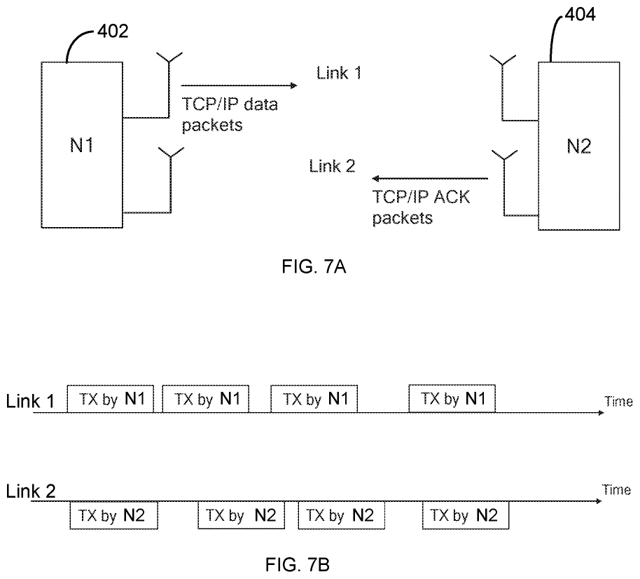

FIGS. 7A and 7B illustrate TCP/IP data dedicated to a first link (link 1) and ACK traffic dedicated to a second link (link 2), in accordance with certain aspects of the present disclosure. As shown in FIG. 7A, the TCI/IP data packets may be sent on link 1 and the associated TCP/IP ACK packets may be sent on link 2. In other words, as shown in FIG. 7B, the transmissions by node 402 may be dedicated to link 1 and the transmissions by node 404 may be dedicated to link 2. In this manner, collisions may not occur on each link since the transmissions by the node 402 are on a different link than the transmissions by node 404. In other words, to reduce (or completely avoid) collisions on the medium, enhancing the overall throughput for TCP/IP, dynamic control may be implemented regarding how TCP/IP data and TCP/ACK are distributed over the two links. As shown, TCP/IP data may be only allowed to be sent on one link (link 1), and TCP/IP ACK may only be sent on the other link (link 2). However, any ratio of traffic on the links may be implemented. For example, 40% of the TCI/IP data may be sent on link 1, 60% of the TCP/IP data may be sent on link 2, 0% of the TCP/IP ACK may be sent on link 1, and 80% of the TCP/IP ACK may be sent on link 2. The determination of the ratios may be based on various link characteristics such as data rates, link performances, or latency of ACK transmissions.

In TCP/IP, the amount of TCP/IP data bytes flowing in one direction (e.g., from node 402 to node 404) may be very different from the amount of TCP/IP ACK bytes flowing in the other direction (e.g., from node 404 to node 402). Also, the TCP/IP traffic generator component 606 may be sensitive to the latency of the TCP/IP ACK frames. In other words, if latency associated with the reception of ACK frames is increased, the traffic generator component 606 may reduce the amount of data traffic, reducing overall throughput. Thus, dedicated ACK frames to a link that cannot fully support the ACK frames (e.g., due to bandwidth limitations on the link) may result in increased latency for the ACK frames and reduced overall throughput. In this case, the ACK frames may be split across multiple links, as described herein. Thus, latency may impact the ratio of how traffic is distributed over the links. Other techniques for controlling latency of ACK frames are described herein.

As described, in MLO, the transmission data rates on the links may be equal or very different. For example, link 1 may have a higher bandwidth than link 2. Thus, greater than 50% of the data traffic may allocated to link 1 and greater than 50% of the ACK traffic may be allocated to link 2. In some aspects, the ratio associated with the allocation of the data and ACK traffic may be based on the overall data rate of the links and/or the difference in the data rates of the links. Suppose the bandwidth or data rate associated with link 1 is very high, allowing for high throughput of data, and the bandwidth or data rate associated with link 2 is low. In that case, a portion of the ACK traffic may be allocated to link 2 and a portion of the ACK traffic may be allocated to link 1. Based on the various link characteristics described, a certain ratio of data and ACK traffic on each link may be identified (e.g., a sweet spot for distributing the TCP/IP data and TCP/ACK frames over the multiple MLO links).

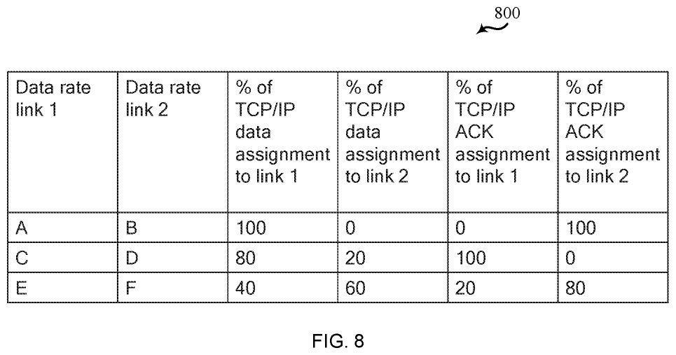

FIG. 8 is a table 800 illustrating different allocations (assignments) of data and ACK for a two-link MLO, in accordance with certain aspects of the present disclosure. For example, for data rates A and B on link 1 and link 2, respectively, 100% of the TCP/IP data may be assigned to link 1 and 100% of TCP/IP ACK may be assigned to link 2. For data rates C and D on link 1 and link 2, respectively, 80% of the TCP/IP data may be assigned to link 1, 20% of the TCP/IP data may be assigned to link 2, and a 100% of TCP/IP ACK may be assigned to link 2. For data rates E and F on link 1 and link 2, respectively, 40% of the TCP/IP data may be assigned to link 1, 60% of the TCP/IP data may be assigned to link 2, 20% of TCP/IP ACK may be assigned to link 1, and 80% of TCP/IP ACK may be assigned to link 2.

While some example provided herein are described with respect to MLO with two links to facilitate understanding, the aspects of the present disclosure may be applied for MLO with any number of links. For example, MLO may be implemented with three links, where a ratio of traffic (e.g., data traffic or ACK traffic) may be determined across the three links.

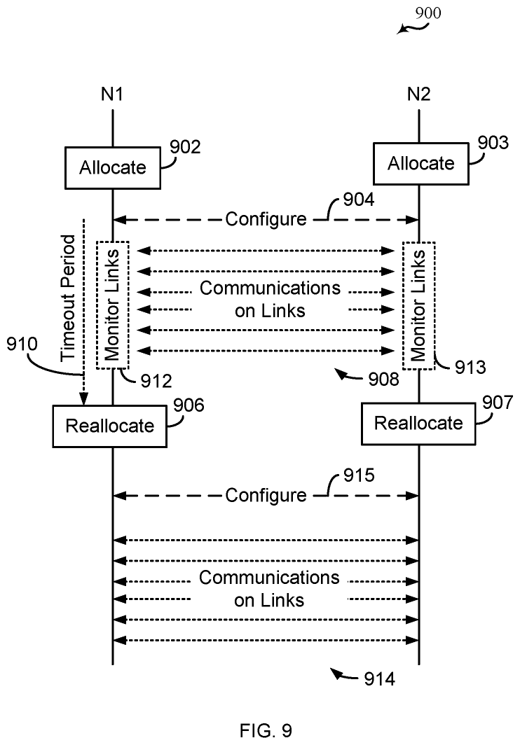

FIG. 9 is a timing diagram illustrating example operations 900 for multi-link communication, in accordance with certain aspects of the present disclosure. As shown, at block 902, a first wireless node (N1) may allocate (e.g., determine a ratio of) a first traffic for transmission on one or more of the multiple links for MLO, and at block 903, the second wireless node (N2) may allocate (e.g., determine a ratio of) a second traffic for transmission on one or more of the multiple links for MLO. For example, based on characteristics of the links, N1 may allocate a certain percentage of the first traffic for transmission by N1 on one or more of the multiple links, and N2 may allocate a certain percentage of the second traffic for transmission by N2 on one or more of the multiple links.

In some aspects, N1 may optionally transmit a message 904 to N2 indicating the determined allocation for the first traffic (or vice versa). The message 904 may be any suitable information element (IE) (e.g., a vendor-specific IE that may be embedded in management frames).

As shown, communications 908 on the multiple links may occur in accordance with the determined allocations. In some aspects, a timeout period 910 may be implemented. For example, after a specific time period has expired, each of the wireless nodes may reassess the links and reallocate (e.g., at blocks 906, 907) ratios of the first traffic and the second traffic on the multiple links. In other words, the characteristics (e.g., data rates) of each link may change over time. Therefore, after a certain amount of time, the links may be reassessed to determine whether a more suitable allocation of traffic is appropriate. In some aspects, at blocks 912, 913, the nodes N1 and N2 may monitor the links for the MLO. Based on the monitoring, if a characteristic (e.g., data rate) of one or more of the links changes more than a certain threshold, the ratios of traffic on each link may be reallocated and communications 914 may occur based on the reallocated ratios. In some aspects, N1 may optionally transmit a message 915 to N2 indicating the determined reallocation for the first traffic (or vice versa). The message 915 may be any suitable IE such as a vendor-specific IE that may be embedded in management frames.

In some aspects, to control latency, a wireless node (e.g., AP) may dynamically adjust a transmit opportunity (TXOP) duration. TXOP refers to the amount of time a transmitter is allowed to control the medium after obtaining ownership of the medium (e.g., initiate transmissions on the medium, where no other node can initiate transmissions on the medium during that TXOP). If the duration of TXOP used by a first wireless node (e.g., AP) is increased, the wireless node may push out a time at which a second wireless node (e.g., STA) transmits TCP-ACK frames (packets), increasing the latency associated with the TCP-ACK frames. On the other hand, if the TXOP duration used by the first wireless node is decreased, the second wireless node may be able to transmit TCP-ACK frames sooner, decreasing the latency associated with the TCP-ACK frames. Thus, in addition to the assignment of a ratio of traffic on each link, a wireless node (e.g., AP) may control or limit the TXOP duration for the node transmitting TCP data.

In some aspects, random backoff medium access parameters may be used to manage latency. To manage latency, a random backoff medium access parameter may be relaxed for the node transmitting TCP data in order to give the other node transmitting TCP-ACK frames a better chance to gain access to the medium (e.g., reducing the TCP-ACK latency). For example, making the random backoff medium access parameters more relaxed may involve increasing the minimum contention window size (CWMin) and/or maximum contention window size (CWMax). Alternatively, the node transmitting TCP-ACK frames may make the random backoff medium access parameters more aggressive to gain better access to the medium. For example, making the random backoff medium access parameters more aggressive may involve reducing the CWMin and/or CWMax. In some aspects, for data frame transmissions, a first wireless node may embed trigger frames in the data frames that give the second wireless node that transmits the TCP-ACK frames better transmit opportunities.

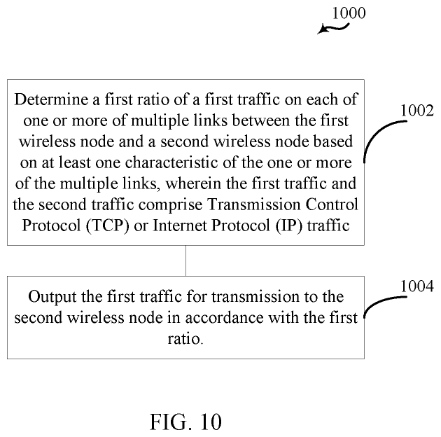

FIG. 10 is a flow diagram illustrating example operations 1000 for wireless communication, in accordance with certain aspects of the present disclosure. The operations 1000 may be performed, for example, by a first wireless node (e.g., MLD), such as AP 102, STA 104, wireless node 402, or wireless node 404.

At block 1002, the first wireless node may determine a first ratio of a first traffic on each of one or more of multiple links between the first wireless node and a second wireless node based on at least one characteristic of the one or more of the multiple links. The first traffic may include TCP/IP traffic.

In some aspects, the at least one characteristic may include one or more data rates associated with the one or more of the multiple links. For example, the one or more data rates may include a data rate of each of the multiple links or an aggregate data rate of the multiple links. In some aspects, the at least one characteristic may include a difference between data rates of the multiple links, as described in more detail herein. In some cases, the first wireless node may assess link performance (e.g., throughput or packet error rate (PER)) on each of the one or more of the multiple links. The at least one characteristic may include the link performance. In some aspects, the at least one characteristic may include a latency associated with the second traffic (e.g., including ACK).

At block 1004, the first wireless node may transmit the first traffic to the second wireless node in accordance with the first ratio. In some aspects, the first wireless node may also receive a second traffic from the second wireless node. The first traffic may a data packets and the second traffic may be ACK for the data packets. In some aspects, the second traffic may be data packets and the first traffic may be ACK for the data packets. The first wireless node may receive a second traffic from the second wireless node in response to transmitting the first traffic, and determine the first ratio by determining to dedicate the first traffic to a first link of the multiple links, the second traffic being dedicated to a second link of the multiple links, as described herein.

In some aspects, the first wireless node may determine a second ratio of the first traffic on each of the one or more of the multiple links based on the one or more data rates changing more than a threshold. In some aspects, the communication at block 1004 may be in accordance with the first ratio for a time period. The first wireless node may determine a second ratio of the first traffic on each of one or more of the multiple links after expiration of the time period.

### Example Communications Device(s)

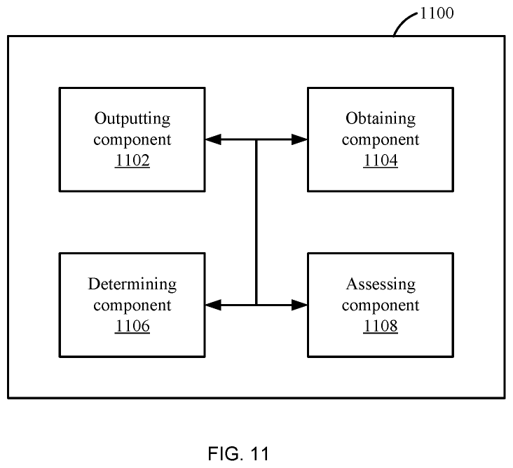

FIG. 11 depicts aspects of an example communications device 1100. In some aspects, communications device 1100 is a station, such as a STA 104 described above with respect to FIGS. 1 and 2. In some aspects, communications device 1100 is an access point, such as an AP 102 described above with respect to FIGS. 1 and 2. As shown, the communication device 1100 may include an outputting component 1102 (e.g., for outputting a traffic for transmission), an obtaining component 1104 (e.g., for obtaining traffic), a determining component 1106 (e.g., for determining a ratio of traffic on one or more links), and assessing component 1108 (e.g., for assessing link characteristics or performance). The outputting component may include an interface, such as a communication bus, which may be used to output signals for transmission (e.g., via a transmitter). The obtaining component may include an interface, such as a communication bus, which may be used to obtain signals (e.g., from a receiver). Means for outputting, means for transmitting, means for obtaining, means for receiving, means for obtaining, means for determining, and/or means for assessing may include one or more processors, transceivers, or other type of circuitry.

### Example Clauses

Implementation examples are described in the following numbered clauses:

Aspect 1: A method for wireless communication at a first wireless node, comprising: determining a first ratio of a first traffic on each of one or more of multiple links between the first wireless node and a second wireless node based on at least one characteristic of the one or more of the multiple links, wherein the first traffic comprises Transmission Control Protocol (TCP) or Internet Protocol (IP) traffic; and outputting the first traffic for transmission to the second wireless node in accordance with the first ratio.

Aspect 2: The method of Aspect 1, wherein: the method further comprises obtaining a second traffic from the second wireless node; the first traffic comprises data packets; and the second traffic comprises acknowledgement (ACK) for the data packets.

Aspect 3: The method of Aspect 1 or 2, wherein: the method further comprises obtaining a second traffic from the second wireless node; the second traffic comprises data packets; and the first traffic comprises ACK for the data packets.

Aspect 4: The method according to any of Aspect 1-3, wherein: the method further comprises obtaining a second traffic from the second wireless node in response to transmitting the first traffic; and determining the first ratio comprises determining to dedicate the first traffic to a first link of the multiple links, the second traffic being dedicated to a second link of the multiple links.

Aspect 5: The method according to any of Aspect 1-4, wherein the at least one characteristic comprises one or more data rates associated with the one or more of the multiple links.

Aspect 6: The method of Aspect 5, wherein the one or more data rates comprises a data rate of each of the multiple links.

Aspect 7: The method of Aspect 5 or 6, wherein the one or more data rates comprises an aggregate data rate of the multiple links.

Aspect 8: The method according to any of Aspect 5-7, further comprising determining a second ratio of the first traffic on each of the one or more of the multiple links based on the one or more data rates changing more than a threshold.

Aspect 9: The method according to any of Aspect 1-8, wherein the at least one characteristic comprises a difference between data rates of the multiple links.

Aspect 10: The method according to any of Aspect 1-9, wherein the at least one characteristic comprises whether a link of the multiple links can support the first traffic being dedicated to the link.

Aspect 11: The method according to any of Aspect 1-10, wherein the transmission is in accordance with the first ratio for a time period, the method further comprising determining a second ratio of the first traffic on each of one or more of the multiple links after expiration of the time period.

Aspect 12: The method according to any of Aspect 1-11, further comprising assessing link performance on each of the one or more of the multiple links, wherein the at least one characteristic comprises the link performance.

Aspect 13: The method according to any of Aspect 1-12, wherein: the method further comprises obtaining a second traffic from the second wireless node; the first traffic comprises data packets and the second traffic comprises acknowledgement (ACK) for the data packets; and the at least one characteristic comprises a latency associated with the second traffic including the ACK for the data packets.

Aspect 14: The method according to any of Aspect 1-13, wherein: the method further comprises obtaining a second traffic from the second wireless node; and the first traffic comprises data packets and the second traffic comprises acknowledgement (ACK) for the data packets; and determining the first ratio comprises allocating a greater amount of the first traffic including the data packets to a first link of the multiple links than a second link of the multiple links based on the first link having a higher data rate than the second link.

Aspect 15: An apparatus for wireless communication at a first wireless node, comprising: one or more processors; memory coupled with the one or more processors; and instructions stored in the memory and executable by the one or more processors to cause the apparatus to: determine a first ratio of a first traffic on each of one or more of multiple links between the first wireless node and a second wireless node based on at least one characteristic of the one or more of the multiple links, wherein the first traffic comprises Transmission Control Protocol (TCP) or Internet Protocol (IP) traffic; and output the first traffic for transmission to the second wireless node in accordance with the first ratio.

Aspect 16: The apparatus of Aspect 15, wherein: the instructions further cause the apparatus to obtain a second traffic from the second wireless node; the first traffic comprises data packets; and the second traffic comprises acknowledgement (ACK) for the data packets.

Aspect 17: The apparatus of Aspect 15 or 16, wherein: the instructions further cause the apparatus to obtain a second traffic from the second wireless node; the second traffic comprises data packets; and the first traffic comprises ACK for the data packets.

Aspect 18: The apparatus according to any of Aspect 15-17, wherein: the instructions further cause the apparatus to obtain a second traffic from the second wireless node in response to transmitting the first traffic; and determining the first ratio comprises determining to dedicate the first traffic to a first link of the multiple links, the second traffic being dedicated to a second link of the multiple links.

Aspect 19: The apparatus according to any of Aspect 15-18, wherein the at least one characteristic comprises one or more data rates associated with the one or more of the multiple links.

Aspect 20: The apparatus of Aspect 19, wherein the one or more data rates comprises a data rate of each of the multiple links.

Aspect 21: The apparatus of Aspect 19 or 20, wherein the one or more data rates comprises an aggregate data rate of the multiple links.

Aspect 22: The apparatus according to any of Aspect 19-21, wherein the instructions further cause the apparatus to determine a second ratio of the first traffic on each of the one or more of the multiple links based on the one or more data rates changing more than a threshold.

Aspect 23: The apparatus according to any of Aspect 15-22, wherein the at least one characteristic comprises a difference between data rates of the multiple links.

Aspect 24: The apparatus according to any of Aspect 15-23, wherein the at least one characteristic comprises whether a link of the multiple links can support the first traffic being dedicated to the link.

Aspect 25: The apparatus according to any of Aspect 15-24, wherein the transmission is in accordance with the first ratio for a time period, the instructions further cause the apparatus to determine a second ratio of the first traffic on each of one or more of the multiple links after expiration of the time period.

Aspect 26: The apparatus according to any of Aspect 15-25, wherein the instructions further cause the apparatus to assess link performance on each of the one or more of the multiple links, wherein the at least one characteristic comprises the link performance.

Aspect 27: The apparatus according to any of Aspect 15-26, wherein: the instructions further cause the apparatus to obtain a second traffic from the second wireless node; the first traffic comprises data packets and the second traffic comprises acknowledgement (ACK) for the data packets; and the at least one characteristic comprises a latency associated with the second traffic including the ACK for the data packets.

Aspect 28: The apparatus according to any of Aspect 15-27, wherein: the instructions further cause the apparatus to obtain a second traffic from the second wireless node; and the first traffic comprises data packets and the second traffic comprises acknowledgement (ACK) for the data packets; and to determine the first ratio, the instructions further cause the apparatus to allocate a greater amount of the first traffic including the data packets to a first link of the multiple links than a second link of the multiple links based on the first link having a higher data rate than the second link.

Aspect 29: A non-transitory computer-readable medium having instructions stored thereon, that when executed by one or more processors at a first wireless node, cause the one or more processors to: determine a first ratio of a first traffic on each of one or more of multiple links between the first wireless node and a second wireless node based on at least one characteristic of the one or more of the multiple links, wherein the first traffic comprises Transmission Control Protocol (TCP) or Internet Protocol (IP) traffic; and output the first traffic for transmission to the second wireless node in accordance with the first ratio.

Aspect 30: An apparatus for wireless communication at a first wireless node, comprising: means for determining a first ratio of a first traffic on each of one or more of multiple links between the first wireless node and a second wireless node based on at least one characteristic of the one or more of the multiple links, wherein the first traffic comprises Transmission Control Protocol (TCP) or Internet Protocol (IP) traffic; and means for outputting the first traffic for transmission to the second wireless node in accordance with the first ratio.

### Additional Considerations

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A method for wireless communication at a first wireless node, comprising:
determining a first ratio of a first traffic on each of one or more of multiple links between the first wireless node and a second wireless node based on at least one characteristic of the one or more of the multiple links, wherein the first traffic comprises Transmission Control Protocol (TCP) or Internet Protocol (IP) traffic; and
outputting the first traffic for transmission to the second wireless node in accordance with the first ratio.

2. The method of claim 1, wherein:
the method further comprises obtaining a second traffic from the second wireless node;
the first traffic comprises data packets; and
the second traffic comprises acknowledgement (ACK) for the data packets.

3. The method of claim 1, wherein:
the method further comprises obtaining a second traffic from the second wireless node;
the second traffic comprises data packets; and
the first traffic comprises ACK for the data packets.

4. The method of claim 1, wherein:
the method further comprises obtaining a second traffic from the second wireless node in response to transmitting the first traffic; and
determining the first ratio comprises determining to dedicate the first traffic to a first link of the multiple links, the second traffic being dedicated to a second link of the multiple links.

5. The method of claim 1, wherein the at least one characteristic comprises one or more data rates associated with the one or more of the multiple links.

6. The method of claim 5, wherein the one or more data rates comprises a data rate of each of the multiple links.

7. The method of claim 5, wherein the one or more data rates comprises an aggregate data rate of the multiple links.

8. The method of claim 5, further comprising determining a second ratio of the first traffic on each of the one or more of the multiple links based on the one or more data rates changing more than a threshold.

9. The method of claim 1, wherein the at least one characteristic comprises a difference between data rates of the multiple links.

10. The method of claim 1, wherein the at least one characteristic comprises whether a link of the multiple links can support the first traffic being dedicated to the link.

11. The method of claim 1, wherein the transmission is in accordance with the first ratio for a time period, the method further comprising determining a second ratio of the first traffic on each of one or more of the multiple links after expiration of the time period.

12. The method of claim 1, further comprising assessing link performance on each of the one or more of the multiple links, wherein the at least one characteristic comprises the link performance.

13. The method of claim 1, wherein:
the method further comprises obtaining a second traffic from the second wireless node;
the first traffic comprises data packets and the second traffic comprises acknowledgement (ACK) for the data packets; and
the at least one characteristic comprises a latency associated with the second traffic including the ACK for the data packets.

14. The method of claim 1, wherein:
the method further comprises obtaining a second traffic from the second wireless node; and
the first traffic comprises data packets and the second traffic comprises acknowledgement (ACK) for the data packets; and
determining the first ratio comprises allocating a greater amount of the first traffic including the data packets to a first link of the multiple links than a second link of the multiple links based on the first link having a higher data rate than the second link.

15. An apparatus for wireless communication at a first wireless node, comprising:
one or more processors;
memory coupled with the one or more processors; and
instructions stored in the memory and executable by the one or more processors to cause the apparatus to:
determine a first ratio of a first traffic on each of one or more of multiple links between the first wireless node and a second wireless node based on at least one characteristic of the one or more of the multiple links, wherein the first traffic comprises Transmission Control Protocol (TCP) or Internet Protocol (IP) traffic; and
output the first traffic for transmission to the second wireless node in accordance with the first ratio.

16. The apparatus of claim 15, wherein:
the instructions further cause the apparatus to obtain a second traffic from the second wireless node;
the first traffic comprises data packets; and
the second traffic comprises acknowledgement (ACK) for the data packets.

17. The apparatus of claim 15, wherein:
the instructions further cause the apparatus to obtain a second traffic from the second wireless node;
the second traffic comprises data packets; and
the first traffic comprises ACK for the data packets.

18. The apparatus of claim 15, wherein:
the instructions further cause the apparatus to obtain a second traffic from the second wireless node in response to transmitting the first traffic; and
determining the first ratio comprises determining to dedicate the first traffic to a first link of the multiple links, the second traffic being dedicated to a second link of the multiple links.

19. The apparatus of claim 15, wherein the at least one characteristic comprises one or more data rates associated with the one or more of the multiple links. 20 The apparatus of claim 19, wherein the one or more data rates comprises a data rate of each of the multiple links.

21. The apparatus of claim 19, wherein the one or more data rates comprises an aggregate data rate of the multiple links.

22. The apparatus of claim 19, wherein the instructions further cause the apparatus to determine a second ratio of the first traffic on each of the one or more of the multiple links based on the one or more data rates changing more than a threshold.

23. The apparatus of claim 15, wherein the at least one characteristic comprises a difference between data rates of the multiple links.

24. The apparatus of claim 15, wherein the at least one characteristic comprises whether a link of the multiple links can support the first traffic being dedicated to the link.

25. The apparatus of claim 15, wherein the transmission is in accordance with the first ratio for a time period, the instructions further cause the apparatus to determine a second ratio of the first traffic on each of one or more of the multiple links after expiration of the time period.

26. The apparatus of claim 15, wherein the instructions further cause the apparatus to assess link performance on each of the one or more of the multiple links, wherein the at least one characteristic comprises the link performance.

27. The apparatus of claim 15, wherein:
the instructions further cause the apparatus to obtain a second traffic from the second wireless node;
the first traffic comprises data packets and the second traffic comprises acknowledgement (ACK) for the data packets; and
the at least one characteristic comprises a latency associated with the second traffic including the ACK for the data packets.

28. The apparatus of claim 15, wherein:
the instructions further cause the apparatus to obtain a second traffic from the second wireless node; and
the first traffic comprises data packets and the second traffic comprises acknowledgement (ACK) for the data packets; and
to determine the first ratio, the instructions further cause the apparatus to allocate a greater amount of the first traffic including the data packets to a first link of the multiple links than a second link of the multiple links based on the first link having a higher data rate than the second link.

29. A non-transitory computer-readable medium having instructions stored thereon, that when executed by one or more processors at a first wireless node, cause the one or more processors to:
determine a first ratio of a first traffic on each of one or more of multiple links between the first wireless node and a second wireless node based on at least one characteristic of the one or more of the multiple links, wherein the first traffic comprises Transmission Control Protocol (TCP) or Internet Protocol (IP) traffic; and
output the first traffic for transmission to the second wireless node in accordance with the first ratio.

30. An apparatus for wireless communication at a first wireless node, comprising:
means for determining a first ratio of a first traffic on each of one or more of multiple links between the first wireless node and a second wireless node based on at least one characteristic of the one or more of the multiple links, wherein the first traffic comprises Transmission Control Protocol (TCP) or Internet Protocol (IP) traffic; and
means for outputting the first traffic for transmission to the second wireless node in accordance with the first ratio.
